(19) United States
(12) Patent Application Publication
(10) Pub. No.: US 2025/0301223 A1
(43) Pub. Date: Sep. 25, 2025

(54) DEVICE INCLUDING A PLURALITY OF OPTICAL ELEMENTS AND APPARATUS

(71) Applicant: CANON KABUSHIKI KAISHA, Tokyo (JP)

(72) Inventors: TAKAMI HIRASAWA, Tochigi (JP); YUICHIRO KATO, Tochigi (JP)

(21) Appl. No.: 19/083,216

(22) Filed: Mar. 18, 2025

(30) Foreign Application Priority Data
Mar. 22, 2024 (JP) 2024-047359

(51) Int. Cl. H04N 23/68; H04N 23/55

(52) U.S. Cl. CPC H04N 23/687; H04N 23/55

(57) ABSTRACT

A device includes an optical system that includes a plurality of optical elements, a movement unit configured to move at least one of the plurality of optical elements in a first direction including a component perpendicular to an optical axis of the optical system, an operation unit that allows rotational operation about the optical axis, and a conversion unit that is coupled to the operation unit and the movement unit and configured to convert the rotational operation of the operation unit into a movement of the movement unit in the first direction, wherein the at least one optical element moves in the first direction to produce one of a tilt effect and a shift effect.

### BACKGROUND

### Technical Field

The aspect of the embodiments relates to a device including a plurality of optical elements and an apparatus.

### Description of the Related Art

Conventionally, imaging devices such as single-lens reflex cameras have been required to capture images according to various applications. As one of them, there are known lens devices having an optical system with a tilt effect of tilting the focal plane so as to focus entirely on an object plane tilted with respect to the optical axis of the imaging optical system, or an optical system with a shift effect of changing (shifting) the imaging angle of view (Japanese Patent Application Laid-Open No. 2019-91027, Japanese Patent Application Laid-Open No. 2023-135457, and Japanese Patent Application Laid-Open No. 2019-537755).

However, if the operability and accuracy of moving the optical system to obtain the tilt effect or shift effect are too low, the optical system cannot be moved to a position desired by the photographer, which may result in reduced imaging efficiency.

### SUMMARY

According to an aspect of the embodiments, a device includes an optical system that includes a plurality of optical elements, a movement unit configured to move at least one of the plurality of optical elements in a first direction including a component perpendicular to an optical axis of the optical system, an operation unit that allows rotational operation about the optical axis, and a conversion unit that is coupled to the operation unit and the movement unit and configured to convert the rotational operation of the operation unit into a movement of the movement unit in the first direction, wherein the at least one optical element moves in the first direction to produce one of a tilt effect and a shift effect.

Further features of the disclosure will become apparent from the following description of exemplary embodiments with reference to the attached drawings.

### BRIEF DESCRIPTION OF THE DRAWINGS

FIG. 1 is a diagram illustrating a lens device and a camera body that constitute a camera system.

FIG. 2 is an electrical configuration diagram of the camera system including the lens device and the camera body.

FIGS. 3A to 3C are diagrams illustrating the Scheimpflug principle.

FIGS. 4A and 4B are exploded perspective views of a motion conversion unit of the lens device.

FIGS. 5A and 5B are diagrams illustrating the movement of a lens made by the motion conversion unit of the lens device.

### DESCRIPTION OF THE EMBODIMENTS

Hereinafter, exemplary embodiments of the disclosure will be described in detail with reference to the drawings. In the drawings, the same components are given the same reference numerals, and duplicated description thereof will be omitted.

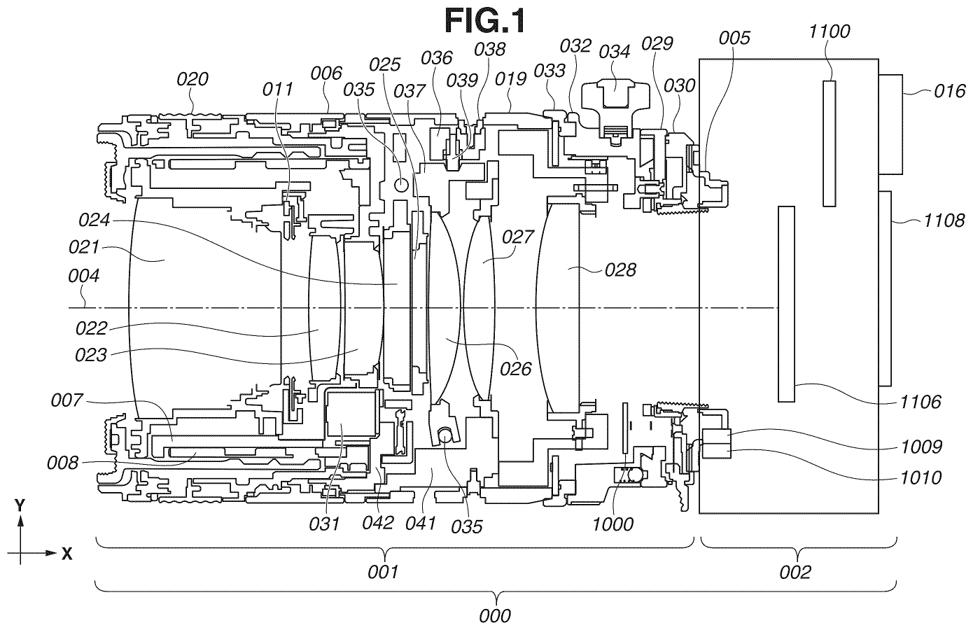

A configuration of a camera system (imaging apparatus) including a lens device (optical device) 001 according to an exemplary embodiment of the disclosure will be described with reference to FIG. 1. FIG. 1 is a cross-sectional view of a configuration of the lens device 001 and a camera body 002 that constitute a camera system 000 according to the exemplary embodiment of the disclosure. The optical axis direction of the lens device 001 is defined as an X-axis, the pitch direction as a Y-axis, and the yaw direction as a Z-axis. FIG. 1 illustrates a cross section along the Z-axis.

The camera body 002 has an imaging unit 1106 (imaging element). The lens device 001 is detachably attached to the camera body 002 that has an imaging element such as a charge-coupled device (CCD) sensor or a complementary metal oxide semiconductor (CMOS) sensor. The image formed via the lens device 001 can be exposed by the imaging unit 1106 for a desired length of time and captured through control of a shutter (not illustrated) by a camera central processing unit (CPU) 1100. The camera body 002 also has a display unit 1108 that displays captured images and having a touch panel function of allowing setting or changing various functions of the camera system 000, and a viewfinder 016 through which the photographer can look inside to check the captured image and obtain eye-controlled focus.

The lens device 001 has lenses as optical elements. The lens device 001 has a first lens unit 021, a second lens unit 022, a third lens unit 023, a fourth lens unit 024, a fifth lens unit 025, a sixth lens unit 026, a seventh lens unit 027, and an eighth lens unit 028. The optical axis of the optical system constituted of these lenses (a plurality of optical elements) is defined as an optical axis 004. The optical system of the lens device 001 can form an image of a subject on the imaging element of the camera body 002. Each lens is held by a lens barrel having a cam follower (not illustrated), and the focal length of the lens device 001 can be changed by changing the positional relationship among the lenses along the optical axis 004. The lens device 001 also has an aperture mechanism 011 that changes the aperture diameter of the optical system by a lens CPU 1000. The aperture mechanism 011 allows the user to change the aperture value by operating an aperture operation ring 020.

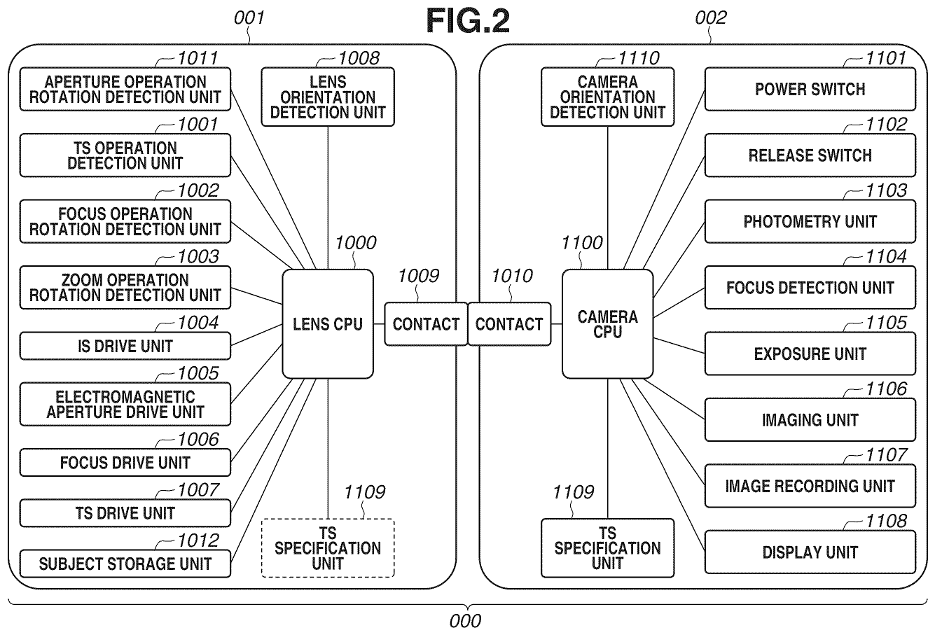

The first lens unit 021 can be adjusted in focus by driving in the direction along the optical axis 004. The mechanism is that the first lens unit 021 is held by a lens barrel having a cam follower, and the cam follower is engaged with a straight groove parallel to the optical axis of a guide barrel 007 and a cam groove inclined with respect to the optical axis of a cam barrel 008. The cam barrel 008 is supported by the guide barrel 007 so as to be rotatable by an actuator 031, and rotates about the optical axis 004 to move the first lens unit 021 along the straight groove provided in the guide barrel 007. The movement distance of the first lens unit 021 can be detected by a position detection unit (not illustrated). Then, a release switch 1102 (illustrated in FIG. 2) or the display unit 1108 provided in the camera body 002 is operated to perform an autofocus operation to automatically focus on a subject. Otherwise, the photographer performs a manual focus operation by operating a focus operation ring 006 provided in the lens device 001 to drive the lens device 001 to a desired focus position. The structure for adjusting the focus is not limited to the guide barrel 007 and the cam barrel 008, and a guide bar (not illustrated) may be used to guide the first lens unit 021 in the direction of the optical axis 004.

The second lens unit 022 and the third lens unit 023 are fixed lens units that do not move along the optical axis 004. The second lens unit 022 and the third lens unit 023 are fixed to a base 042. The guide barrel 007 is also fixed to the base 042. Hereinafter, “direction orthogonal to the optical axis 004” can be rephrased as “a first direction”. In one embodiment, the first direction is orthogonal to the optical axis 004, but may be any direction that includes a component perpendicular to the optical axis 004.

The fourth lens unit 024 and the sixth lens unit 026 are driven in the same direction orthogonal to the optical axis 004 to produce a tilt effect of tilting the focal plane with respect to the imaging plane. The fourth lens unit 024 and the sixth lens unit 026 may be moved in opposite directions to obtain a tilt effect. The fourth lens unit 024 and the sixth lens unit 026 are guided by a conversion member 036 and a first guide member 035 to move in the first direction 004 by operation of a tilt operation ring 019 (operation member). The tilt operation ring 019 (operation member) can be rotated about the optical axis 004 of the optical system. The structures of the tilt operation ring 019, the conversion member 036, the fourth lens unit 024, and the sixth lens unit 026 will be described below in detail.

The fifth lens unit 025 is sandwiched between the fourth lens unit 024 and the sixth lens unit 026, and is a fixed lens unit that does not move in the first direction 004 or along the optical axis 004. The seventh lens unit 027 is also a fixed lens unit that does not move in the direction along the optical axis 004. A base 041 that fixes the fifth lens unit 025 and the seventh lens unit 027 is also fixed to the lens device 001.

The eighth lens unit 028 is a fixed lens unit that does not move in the direction along the optical axis. The eighth lens unit 028 is fixed by a base (not illustrated), and the base rotatably supports the tilt operation ring 019 together with the base 041.

The lens device 001 has a mount 005 that can be connected and fixed to a mount (not illustrated) of the camera body 002. The mount 005 is fixed to a fixing portion 030. The fixing portion 030 has a whole rotation portion 029 provided so as to be rotatable about the center of the mount 005. The units provided closer to the subject than the fixing portion 030 of the lens device 001 rotate together by the rotation of the whole rotation portion 029. The whole rotation portion 029 has a shift portion 032 provided so as to be movable in the first direction 004. When the shift operation portion 034 is operated, a part of the lens device 001 or the units provided closer to the subject than the shift portion 032 move together in the first direction 004. In the present exemplary embodiment, the shift operation portion 034 is a knob type, but may be a cylindrical operation ring with the optical axis 004 as a rotation center. The shift portion 032 has a tilt-shift (TS) rotation portion 033 provided so as to be rotatable about the optical axis 004. The units provided closer to the subject than the TS rotation unit 033 of the lens device 001 rotate together by the rotation of the TS rotation portion 033.

A lens-side electrical contact 1009 and a camera-side electrical contact 1010 are provided to connect the lens CPU 1000 of the lens device 001 and the camera CPU 1100 of the camera body 002, so that the settings made on the camera side can be reflected in the lens device 001.

FIG. 2 is a diagram illustrating an electrical configuration of the camera system 000 (imaging device) including the lens device 001 and the camera body 002.

First, a flow of control in the camera body 002 will be described. The camera CPU 1100 is constituted of a microcomputer. The camera CPU 1100 controls the operation of each portion inside the camera body 002. When the lens device 001 is attached, the camera CPU 1100 communicates with the lens CPU 1000 provided in the lens device 001 via the lens-side electrical contact 1009 and the camera-side electrical contact 1010.

The information (signal) transmitted from the camera CPU 1100 to the lens CPU 1000 includes driving amount information and defocus information of the first lens unit 021. The information also includes orientation information of the camera body 002 based on a signal from a camera orientation detection unit 1110 such as an acceleration sensor (not illustrated). The information further includes subject distance information and defocus information of a desired subject on which the photographer wishes to focus, based on a signal from a TS specification unit 1109 that specifies the subject, and information indicating a desired imaging range (field of view).

The information (signal) transmitted from the lens CPU 1000 to the camera CPU 1100 includes optical information such as the imaging magnification of the lens, and lens function information such as zoom (if a zoom lens is used) and vibration isolation (if an image stabilizing mechanism is used) installed in the attached lens device 001. The information also includes orientation information from a lens orientation detection unit 1008 such as a gyro sensor or an acceleration sensor.

The lens-side electrical contact 1009 and the camera-side electrical contact 1010 include contacts for supplying power from the camera body 002 to the lens device 001.

A power switch 1101 is a switch that can be operated by the photographer to start the camera CPU 1100 and start the supply of power to the actuators, sensors, and the like in the camera system 000. The release switch 1102 is a switch that can be operated by the photographer, and includes a first stroke switch SW1 and a second stroke switch SW2. A signal from the release switch 1102 is input to the camera CPU 1100. The camera CPU 1100 enters an imaging preparation state in response to the input of an ON signal from the first stroke switch SW1. In the imaging preparation state, the luminance of a subject is measured by a photometry unit 1103, and focus detection is performed by a focus detection unit 1104.

The camera CPU 1100 calculates the aperture value of the aperture mechanism 011 and the exposure amount (shutter time) of the imaging unit 1106 based on the result of photometry by the photometry unit 1103. The camera CPU 1100 also determines the driving amount (including the driving direction) of the first lens unit 021 in which a focus drive unit 1006 is used as a driving source to obtain a state of focus on the subject, based on focus information (defocus amount and defocus direction) that is the detection result of the focus state of the imaging optical system by the focus detection unit 1104. The information of driving amount information (driving amount information of the first lens unit 021) is transmitted to the lens CPU 1000. The lens CPU 1000 controls the operation of each component of the lens device 001.

The lens device 001 of the present exemplary embodiment is configured to obtain a tilt effect of tilting the focal plane with respect to the imaging plane by driving the fourth lens unit 024 and the sixth lens unit 026 in the first direction 004. If the fourth lens unit 024 and the sixth lens unit 026 are electrically driven by an actuator (not illustrated), the camera CPU 1100 calculates the tilt driving amounts for focusing on a desired subject specified by the TS specification unit 1109. The information on these driving amounts is transmitted from the camera CPU 1100 to the lens CPU 1000, thereby controlling the driving of the fourth lens unit 024 and the sixth lens unit 026.

A plurality of subjects may be specified by the TS specification unit 1109. Even if the subjects are at different distances, it is possible to focus on the subjects as far as they are present on an object plane that is tilted due to the tilt effect described above.

If the lens device 001 has an image stabilizing function, the camera CPU 1100 in a predetermined imaging mode starts eccentric driving of an image stabilizing lens (not illustrated), that is, starts control of the hand-shake preventive operation (eccentric drive control).

When an ON signal is input from the second stroke switch SW2, the camera CPU 1100 transmits an aperture drive command to the lens CPU 1000, and sets the aperture mechanism 011 to the calculated aperture value. The camera CPU 1100 also transmits an exposure start command to an exposure unit 1105 to perform an opening operation of a shutter (not illustrated), and causes the imaging element of the imaging unit 1106 to perform photoelectric conversion of the subject image, that is, an exposure operation.

An imaging signal from the imaging unit 1106 is converted into a digital signal by a signal processing unit in the camera CPU 1100, and then subjected to various correction processes before being output as an image signal. The image signal (data) is recorded and saved on a recording medium such as a semiconductor memory including a flash memory, a magnetic disk, or an optical disk in an image recording unit 1107.

An image captured by the imaging unit 1106 can be displayed on a display unit 1108, which is a liquid crystal display or an organic electroluminescence (EL) display, during imaging. Furthermore, an image recorded in the image recording unit 1107 can also be displayed on the display unit 1108.

In recent years, this type of display has been equipped with touch operation technology, which makes it possible to select and focus on a subject on a monitor for live view imaging. That is, the TS specification unit 1109 may be included in the display unit 1108.

Next, a flow of control in the lens device 001 will be described. A focus operation rotation detection unit 1002 includes the focus operation ring 006 and a sensor (not illustrated) that detects the rotation of the focus operation ring 006. An aperture operation rotation detection unit 1011 includes the aperture operation ring 020 and a sensor (not illustrated) that detects the rotation of the aperture operation ring 020. A zoom operation rotation detection unit 1003 includes a zoom operation ring and a sensor (not illustrated) that detects the rotation of the zoom operation ring. This is the case where the lens device is equipped with a zoom operation ring, and the lens device 001 of the present exemplary embodiment is not equipped with a zoom operation ring. A subject storage unit 1012 defines and stores the spatial position of the subject specified by the TS specification unit 1109 or the display unit 1108 in the imaging range, in terms of the subject distance and spatial coordinates.

The TS operation detection unit 1001 includes a manual operation unit for obtaining tilt and shift effects, and a sensor (not illustrated) for detecting the operation amount of the manual operation unit. An image stabilizing (IS) drive unit 1004 includes a drive actuator for an image stabilizing lens (not illustrated) that performs an image stabilizing operation, and a drive circuit for the drive actuator. In the case of a lens device without an image stabilizing function, this structure is not necessary.

The focus drive unit 1006 includes the first lens unit 021 that performs a focusing operation, and the actuator 031 that moves the first lens unit 021 in the optical axis direction according to driving amount information. The driving amount information is determined based on a signal from the camera CPU 1100 as described above. Alternatively, the driving amount information may be determined from a signal that indicates the focus position manually specified by operating the focus operation rotation detection unit 1002.

An electromagnetic aperture drive unit 1005 controls its driving source by the lens CPU 1000 that has received an aperture drive command from the camera CPU 1100, and operates the aperture mechanism 011 to an open state corresponding to the specified aperture value. The electromagnetic aperture drive unit 1005 also operates the aperture mechanism 011 in the same way when the photographer specifies a desired aperture value by operating the aperture operation ring 020.

The TS drive unit 1007 performs a tilt operation such that the lens CPU 1000, upon receipt of information on the subject distance, position, and the imaging range from the camera CPU 1100, controls its driving source to obtain a desired subject plane (focus plane), and performs a shift operation to obtain a desired imaging range. Needless to say, the lens CPU 1000 controls the TS drive unit 1007 and the focus drive unit 1006 so that they operate optimally to obtain the desired focus. The lens device 001 of the present exemplary embodiment has optical characteristics of changing the focus even if the subject distance does not change due to the shift operation. However, needless to say, the TS drive unit 1007 and the focus drive unit 1006 are optimally controlled in accordance with the optical characteristics. Nevertheless, this is limited to the case where the tilt operation and shift operation of the lens device 001 are electrically driven by an actuator.

A gyro sensor (not illustrated) is arranged (fixed) inside the lens device 001 and electrically connected to the lens CPU 1000. The gyro sensor detects the angular velocities of a vertical (pitch-direction) shake and horizontal (yaw-direction) shake of the camera system 000, which are angular shakes, and outputs the detected values to the lens CPU 1000 as angular velocity signals. The lens CPU 1000 electrically or mechanically integrates the angular velocity signals in the pitch direction and yaw direction from the gyro sensor to calculate a pitch-direction shake amount and a yaw-direction shake amount (collectively referred to as angular shake amount), which are the displacement amounts in these directions. The lens CPU 1000 controls the IS drive unit 1004 based on the composite displacement amount of the above-described angular shake amount and a parallel shake amount to drive and shift the image stabilizing lens, thereby performing angular shake correction and parallel shake correction. As described above, some lens devices do not have an image stabilizing function, in which case this structure/function is unnecessary. The lens CPU 1000 controls the focus drive unit 1006 based on the amount of a focus shake to drive the first lens unit 021 in the optical axis direction, thereby correcting the focus shake.

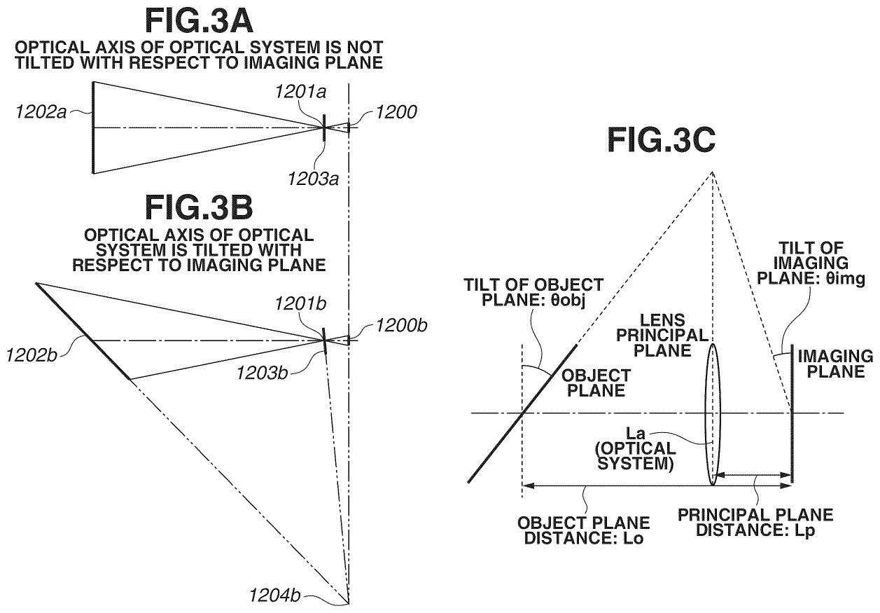

FIGS. 3A to 3C are diagrams for describing the Scheimpflug principle. When the optical axis of the optical system in the lens device 001 is tilted with respect to the imaging unit 1106, the in-focus range on the subject side is determined by the Scheimpflug principle. FIG. 3A illustrates the in-focus range in which the optical axis of the optical system is not tilted with respect to the imaging plane, and FIG. 3B illustrates the in-focus range in which the optical axis of the optical system is tilted with respect to the imaging plane. The diagrams illustrate an imaging plane 1200a, an imaging plane 1200b, an optical system 1201a, an optical system 1201b, an in-focus subject plane 1202a, a subject plane 1202b, and a principal plane 1203a and a principal plane 1203b of the optical systems. The Scheimpflug principle is that when the imaging plane 1200b and the principal plane 1203b of the optical system 1201b intersect at an intersection 1204b on a certain straight line, the subject plane 1202b also passes through the intersection 1204b, as illustrated in FIG. 3B.

If the subject to be imaged has a depth, it is possible to focus on the subject from the foreground to the background by tilting the subject plane 1202b along the depth. If the user wishes to focus on a deep part with a lens that does not have a tilt mechanism, it is common to narrow the aperture to increase the depth of field. However, with a tilt lens, it is possible to obtain focus according to the depth by tilting even if the aperture is open.

Conversely, the principal plane of the optical system 1201b may be tilted in the direction opposite to the tilt of the subject with a depth, so that the subject plane 1202b can intersect the subject's depth direction at an angle close to a right angle. In this case, the in-focus range can be made extremely narrow to obtain a diorama-style image.

However, the lens device of the present exemplary embodiment does not tilt the optical system, but rather uses an image plane tilt caused by the decentering of the lens to generate a tilt θobj of the subject plane 1202c. However, if the Scheimpflug principle is applied to the principal plane 1203c of the lens that does not tilt and the subject plane 1202c, the imaging plane 1200c should generate an image plane tilt of an angle θimg. Therefore, the lens 1201c of the lens device 001 of the present exemplary embodiment is configured to focus on the desired subject by correcting this angle θimg such that the subject plane can be tilted without tilting the imaging plane 1200c.

On the other hand, if a predetermined effect of imaging plane tilt correction is to be ensured, the amount of decentering of the lens 1201c will increase, and composition displacement will become large. This disadvantage is solved by moving another lens designed to reduce aberration fluctuations during decentering, that is, by decentering the fourth lens unit 024 and the sixth lens unit 026 equivalent to the lens 1201c.

### (Configuration of Tilt Operation Ring)

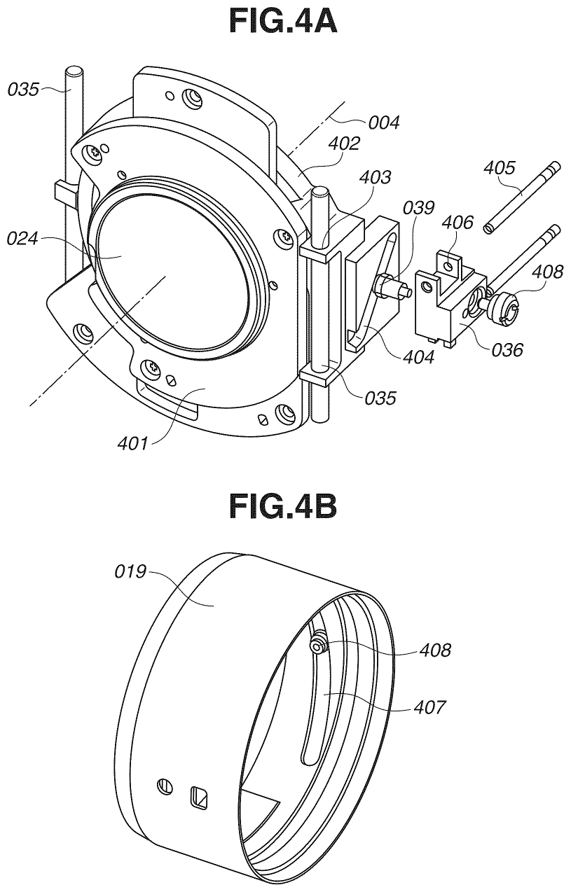

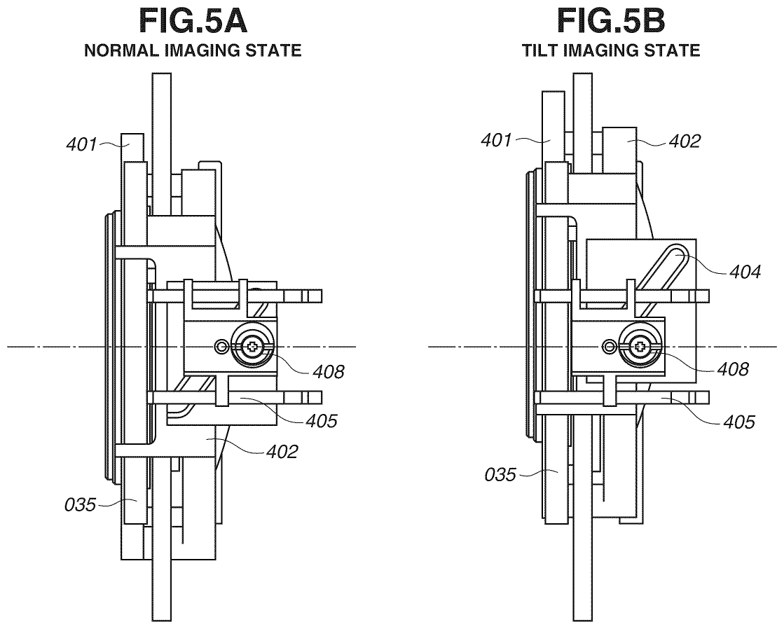

Next, a configuration for rotationally operating the tilt operation ring 019, which is a main part of the exemplary embodiment of the disclosure, to drive the fourth lens unit 024 and the sixth lens unit 026 in the first direction 004, will be described with reference to FIGS. 4A, 4B, 5A, and 5B.

FIG. 4A is an exploded perspective view of a configuration used for converting the rotational movement of the tilt operation ring 019 into driving of the fourth lens unit 024 and the sixth lens unit 026 in the first direction 004. FIG. 4B is a diagram illustrating an inner peripheral shape of the tilt operation ring 019.

The fourth lens unit 024 is held integrally in a fourth lens barrel 401. The sixth lens unit 026 is held integrally in a sixth lens barrel 402. The fourth lens barrel 401 is further fixed integrally to the sixth lens barrel 402 with screws or adhesive not illustrated. The sixth lens barrel 402 includes guide holes 403 through which first guide members 035 are inserted, which restrict the movement direction of the sixth lens barrel 402 in the first direction 004. A first cam groove 404 is provided at a certain angle with respect to the optical axis 004 in the phase where the guide holes 403 of the sixth lens barrel 402 are provided.

A tip of a cam pin 039 (first roller member) slidably fits into each first cam groove 404. A shaft portion slidable relative to the conversion member 036 is provided on the side of the cam pin 039 opposite to the fitting portion with the first cam groove 404. Further, a biasing member (not illustrated) is provided between the cam pin 039 and the conversion member 036, which biases the tip of the cam pin 039 into the first cam groove 404 to suppress backlash between the components. The first cam groove 404 and the first roller member may be reversely arranged.

The conversion member 036 includes a second guide hole 406 through which a second guide member 405 passes to restrict the movement direction of the conversion member 036 to the direction of the optical axis 004. The conversion member 036 also includes a cam roller 408 (second roller member) that slides in a second cam groove 407 provided on the inner periphery of the tilt operation ring 019. The second cam groove 407 is provided at a certain angle with respect to the optical axis 004 at which the tilt operation ring 019 is deployed. The second cam groove 407 and the second roller member 408 may be reversely arranged.

FIGS. 5A and 5B are diagrams illustrating the movement of the fourth lens barrel 401 and the sixth lens barrel 402 with rotation of the tilt operation ring 019. FIG. 5A illustrates a normal imaging state without a tilt effect, and FIG. 5B illustrates a tilt imaging state in which a tilt effect is obtained by rotating the tilt operation ring 019.

When the photographer rotates the tilt operation ring 019 for tilt imaging, the second cam groove 407 provided in the inner periphery of the tilt operation ring 019 also rotates together with the tilt operation ring 019. The position of the contact surface between the cam roller 408 and the second cam groove 407 changes by the rotation of the second cam groove 407.

The tilt operation ring 019 is rotated at a fixed position in the direction of the optical axis 004 due to a bayonet portion (not illustrated). Since the position of the tilt operation ring 019 does not change in the direction of the optical axis 004, the cam roller 408 moves as a result of a change in the contact surface of the second cam groove 407. The cam roller 408 is fixed to the conversion member 036, and the conversion member 036 is moved in the direction of the optical axis 004 by the second guide member 405. Therefore, when the tilt operation ring 019 is rotated, the conversion member 036 can be moved in the direction of the optical axis 004.

When the tilt operation ring 019 is rotated to move the conversion member 036, the cam pin 039 moves in the direction of the optical axis 004. The cam pin 039 is slidably fitted in the first cam groove 404, and the cam pin 039 is about to move along the first cam groove 404. However, since the movement of the conversion member 036 holding the cam pin 039 is restricted to the direction of the optical axis 004, the driving force of the cam pin 039 is transmitted to the first cam groove 404 as a force in the direction of the optical axis 004. On the other hand, the movement of the sixth lens barrel 402 provided with the first cam groove 404 is restricted by the first guide member 035 to the first direction 004. As a result, the driving force of the cam pin 039 in the direction of the optical axis 004 moves the sixth lens barrel 402 having the first cam groove 404 in the first direction 004. Since the fourth lens barrel 401 is integrally held by the sixth lens barrel 402, the fourth lens barrel 401 can also move in the first direction 004 in the same manner.

With the above-described configuration, the fourth lens barrel 401 and the sixth lens barrel 402 can be driven in the first direction 004 via the conversion member 036 by the rotational movement of the tilt operation ring 019. With this configuration, the rotational movement of the tilt operation ring 019 can be converted into the first direction 004 via the cam mechanism of the first cam groove 404 and the second cam groove 407, thereby increasing the operation distance. The longer the operation distance, the higher the movement resolution in the first direction 004, so that it is possible to improve the accuracy of moving the fourth lens barrel 401 and the sixth lens barrel 402 by the photographer to a desired position. In addition, the tilt operation ring 019 is operated by a rotational movement about the optical axis 004, like the focus operation ring 006 and the aperture operation ring 020, so there is no need to learn a new operation method for tilt imaging.

In addition, if the mass of the lens to be driven increases, it is possible to suppress the increase in operating torque and reduce the impact on the operating feel by changing the angles of the two cam grooves, the first cam groove 404 and the second cam groove 407.

The cam roller 408 in the present exemplary embodiment may be an eccentric roller in which the axis of the attachment portion to the conversion member 036 and the axis of the portion sliding in the second cam groove 407 are eccentric. By using an eccentric roller, even if a tilt effect occurs when the tilt operation ring 019 is in a non-tilt imaging position due to assembly variations or part tolerances, it is possible to move the conversion member 036 for adjustment by rotating the eccentric roller.

Although a configuration in the present exemplary embodiment has been described in which the operation is converted by the cam groove and the roller, a gear coupling configuration using gears in the conversion unit may be adopted instead. The lens device of the present exemplary embodiment moves the lens in the first direction to obtain a tilt effect. Alternatively, the lens may be moved in the first direction to obtain a shift effect of moving the imaging range.

According to the lens device of the present exemplary embodiment, the optical system can be moved to a desired position without the operating accuracy being affected by the controllability or stopping accuracy of the drive actuator. In addition, the operability can be improved compared to the conventional method of obtaining a tilt effect by tilting the entire lens barrel using a lever coupled to a cylindrical operating ring.

Exemplary embodiments of the disclosure have been described above. However, the disclosure is not limited to these exemplary embodiments, and various modifications and variations are possible within the scope of the disclosure. The disclosure can be applied to lens devices that can be attached to camera bodies of single-lens reflex digital cameras and mirrorless cameras.

This application claims the benefit of Japanese Patent Application No. 2024-047359, filed Mar. 22, 2024, which is hereby incorporated by reference herein in its entirety.

What is claimed is:

1. A device comprising:
an optical system that includes a plurality of optical elements;
a movement unit configured to move at least one of the plurality of optical elements in a first direction including a component perpendicular to an optical axis of the optical system;
an operation unit that allows rotational operation about the optical axis; and
a conversion unit that is coupled to the operation unit and the movement unit and configured to convert the rotational operation of the operation unit into a movement of the movement unit in the first direction,
wherein the at least one optical element moves in the first direction to produce one of a tilt effect and a shift effect.

2. The device according to claim 1, wherein the conversion unit and the movement unit are coupled together by a first cam groove that is provided in one of the conversion unit and the movement unit and a first roller member that is provided in the other of the conversion unit and the movement unit and slides in the first cam groove.

3. The device according to claim 1, wherein the conversion unit and the operation unit are coupled together by a second cam groove that is provided in one of the conversion unit and the operation unit and a second roller member that is provided in the other of the conversion unit and the operation unit and slides in the second cam groove.

4. The device according to claim 1, wherein the movement unit has a first guide member that guides the at least one optical element in the first direction.

5. The device according to claim 1, wherein the conversion unit has a second guide member that guides the movement of the conversion unit in the direction along the optical axis.

6. The device according to claim 1, wherein the conversion unit and the movement unit are coupled together by a gear.

7. The device according to claim 1, wherein the conversion unit and the operation unit are coupled together by a gear.

8. An apparatus comprising:
the device according to claim 1; and
an element configured to capture an image of a subject via the device.

9. The apparatus according to claim 8, wherein, in the device, the conversion unit and the movement unit are coupled together by a first cam groove that is provided in one of the conversion unit and the movement unit and a first roller member that is provided in the other of the conversion unit and the movement unit and slides in the first cam groove.

10. The apparatus according to claim 8, wherein, in the device, the conversion unit and the operation unit are coupled together by a second cam groove that is provided in one of the conversion unit and the operation unit and a second roller member that is provided in the other of the conversion unit and the operation unit and slides in the second cam groove.

11. The apparatus according to claim 8, wherein, in the device, the movement unit has a first guide member that guides the at least one optical element in the first direction.

12. The apparatus according to claim 8, wherein, in the device, the conversion unit has a second guide member that guides the movement of the conversion unit in the direction along the axis.

13. The apparatus according to claim 8, wherein, in the device, the conversion unit and the movement unit are coupled together by a gear.

14. The apparatus according to claim 8, wherein, in the device, the conversion unit and the operation unit are coupled together by a gear.
